(19) United States
(12) Patent Application Publication
(10) Pub. No.: US 2008/0165720 A1
(43) Pub. Date: Jul. 10, 2008

(54) Method and Arrangement For Cooperative Relaying

(76) Inventors: Rong Hu, Beijing (CN); Zhang Zhang, Beijing (CN); Peter Larsson, Solna (SE)

Correspondence Address: NIXON & VANDERHYE, PC, 901 NORTH GLEBE ROAD, 11TH FLOOR, ARLINGTON, VA, 22203, US

(21) Appl. No.: 11/884,454

(22) PCT Filed: Feb. 17, 2005
(86) PCT No.: PCT/SE2005/000227

§ 371 Date: Aug. 16, 2007

(51) Int. Cl. H04B 7/14

(52) U.S. Cl. 370/315

(57) ABSTRACT

In a method for relaying deployment in a wireless communication system comprising a transmitting node with multiple antennas for communicating with at least one receiving node via at least two relay nodes, a data stream at the transmitting node is partitioned into at least two data substreams, each of which is beamformed and transmitted over a first link to a respective of the relay nodes; subsequently at least one restorable representation of each received substream is forwarded over a second link to the receiving node from the two relay nodes; and finally the received and decoded representations are multiplexed to form an output signal at the receiving node corresponding to the original data stream.

### TECHNICAL FIELD

The present invention relates to communication systems in general, specifically to relaying deployment in such systems.

### BACKGROUND

Future wireless and/or cellular systems are expected to either require increased coverage, support higher data rates or a combination of both. In addition, the cost aspect of building and maintaining the system is expected to become of greater importance in the future. As data rates and/or communication distances are increased, the problem of increased battery consumption also needs to be addressed.

One aspect is rethinking the topology used in existing systems, as there has been little change of topology over the three generations of cellular networks. For instance, it is well known that multihopping, being an example of another communication topology, offers possibilities of significantly reduced path loss between communicating (relay) entities, which may benefit the user. In the following, another type of topology will be discussed that considers two-hop relaying combined with aspects of advanced antenna systems. This is a research area, yet in its infancy, that employs cooperation among multiple stations as a common denominator. In recent research literature, it goes under several names, such as cooperative diversity, cooperative coding, virtual antenna arrays, etc. A good general overview over cooperative communication schemes is given in [1]. The general benefits of cooperation between stations in wireless communication can be summarized as higher data rates, reduced outage (due to some forms of diversity), increased battery life and extended coverage (e.g. for cellular systems).

First, the area of advanced antennas is discussed, and subsequently, the state of the art with respect to cooperative relaying is considered.

Advanced antennas and spatial coding: Methods to enhance system performance in a cellular communication system is a very active research area. One such method is to employ multiple antennas at the base stations (BSs), and thereby provide valuable diversity gains that mitigate any channel fluctuations imposed by fading. In downlink, (from BS to a mobile station (MS)) so called transmit diversity can be employed and in uplink, (from MS to BS) receiver diversity can be used. Of course, the MS may also be equipped with multiple antennas, but a MS is generally space limited (which inherently limits the number of antennas at the MS) and therefore the BS solution is often to prefer. Many well known schemes exist both for receiver and transmitter diversity. For receiver diversity, selection diversity, maximum ratio combining or interference rejection combining may be used. For the newer transmit diversity area, possible options include delay diversity, Alamouti diversity, coherent combining based diversity.

Transmit diversity, in particular Alamouti diversity, belongs to a class of coding schemes that are often denoted space-time coding (STC). In STC schemes, it is generally assumed that the transmitter is equipped with multiple antennas while the receiver has only one or alternatively multiple antennas. Transmitted signals are then encoded over the multiple transmit antennas and sometimes also in time domain. With multiple antennas at both transmitter and receiver side, the channel is often denoted a Multiple Input Multiple Output channel (MIMO). A MIMO channel can be used mainly for two reasons, either for diversity enhancements, i.e. providing a more robust channel under channel fluctuations, or for so called spatial multiplexing, i.e. providing a set of parallel and multiplexed MIMO sub channels. The benefit of spatial multiplexing is that extremely high spectrum efficiency is achievable. A background on MIMO communication is given in [2].

Repeaters: Another well-known method for enhancing system performance is to deploy repeaters in areas where coverage is poor. The basic operation for the repeater is to receive a radio signal, amplify it, and retransmit it. Repeaters may use the same frequency for reception and transmission, or optionally shift the transmit frequency for increased output-input isolation avoiding risk for feedback and oscillations.

Cooperative Relaying: (a.k.a. Virtual antenna arrays) Traditionally, the previously mentioned repeaters are fairly unintelligent. However, more recently, the idea of cooperative relaying with smarter repeaters (or relays) has received some interest. The idea is that relays can cooperate in forwarding a signal from a transmitter to a receiver or multiple receivers [3]. The cooperation may for instance involve aspects of coherent combining, STC (e.g. Alamouti diversity), and be of regenerative (decode and forward data) or non-regenerative (amplify and forward data) nature. The number of hops is (generally) limited to two hops, i.e. one hop to the relay station(s), and one hop to the receiving station.

One special and interesting type of cooperative relaying (or virtual antenna arrays) is when MIMO is exploited. This has been studied extensively by Dohler et al., e.g. in [4], [5] and [6].

Dohler's scheme, according to prior art, is founded on that a superposition of multiple sub stream signals is transmitted to the receiver from the relays over multiple channels, but this is not an optimum solution in the sense that higher throughput could be achieved given the invested power (or energy). Also, the aspect on how to select relays is left fully un-addressed. Moreover, the aspect on how to assign power among different relays in an efficient way has not been addressed in Dohler's scheme, i.e. all involved relays have the equal power [5], [6].

### SUMMARY

An object of the present invention is to provide an improved relaying scheme in a communication system.

A specific object is to enable improved cooperative relaying in a communication system.

A specific object is to enable a method for spatial multiplexing with improved spectrum efficiency.

Another specific object is to enable a method for allocating power between a transmitter and relays with decreased power consumption.

Yet another specific object is to enable a method for allocating power between a transmitter and relays to reduce the generated interference.

Another specific object is to enable cooperative relaying with increased overall system capacity.

These and other objects are achieved with a method and arrangements in accordance with the attached claims.

Briefly, the present invention comprises partitioning a data stream into a plurality of data substreams, beamforming each respective data substream to a respective relay, and forwarding the data substreams orthogonally to a receiving unit.

More specifically, the invention comprises enabling feedback of channel state information, whereby the transmit power and/or the bit rate for each data substream can be adjusted to provide optimal transmission of information content.

Advantages of the present invention include:
High spectrum efficiency.
Decreased power consumption due to efficient power allocation between the transmitter and relays.
Reduced generation of interference due to efficient power allocation between the transmitter and relays.
Increased overall system capacity.

### BRIEF DESCRIPTION OF THE DRAWINGS

The invention, together with further objects and advantages thereof, may best be understood by making reference to the following description taken together with the accompanying drawings, in which:

FIG. 1 is a schematic illustration of a system according to the invention;

FIG. 2 is a schematic flow diagram of an embodiment of a method according to the invention;

FIG. 3 is a schematic illustration of part of a specific embodiment of the invention;

FIG. 4 is a schematic illustration of another specific embodiment of a method according to the invention;

FIG. 5 is a schematic illustration of another specific embodiment of a method according to the invention;

FIG. 6 is a schematic illustration of an embodiment of a system according to the invention;

FIG. 7 is a diagram illustrating benefits of the invention when compared to prior art.

FIG. 8 is a schematic illustration of spatial distribution of relay nodes according to the invention;

FIG. 9 is a schematic illustration of another spatial distribution of relay nodes according to the invention;

### DETAILED DESCRIPTION

Frequently used abbreviations are according to the following:
BS Base Station
CSI Channel State Information
MAI Multiple Access Interference
MS Mobile Station
MIMO Multiple Input Multiple Output
SNR Signal-to-Noise Ratio
STC Space-Time Coding

The present invention addresses a special relay architecture that is related to cooperative relaying, also referred to as virtual antenna arrays, cooperative diversity etc. [1]. In a sense, cooperative relaying may be viewed as a degenerated case of multi-hopping involving only two hops, but at the same time generalized to and allowing for parallel paths as well as signal processing to be exploited. In addition, cooperative relaying may exploit various forms of relayed information such as basic repeater (non-regenerative) functionality or “decode and forwarding” (regenerative) as done traditionally in multi-hop networks.

The basic idea of the present invention is that a transmitter, being equipped with multiple antennas and having multiple MIMO-substreams, beamforms one or more MIMO-substreams to each of a plurality of relay nodes, and each relay node is capable of decoding the substream prior to forwarding detected data to a receiver node over a channel being substantially orthogonal with respect to other relay channels. This is made possible by adapting the transmitters' antenna weight matrix to the channels of the different relays.

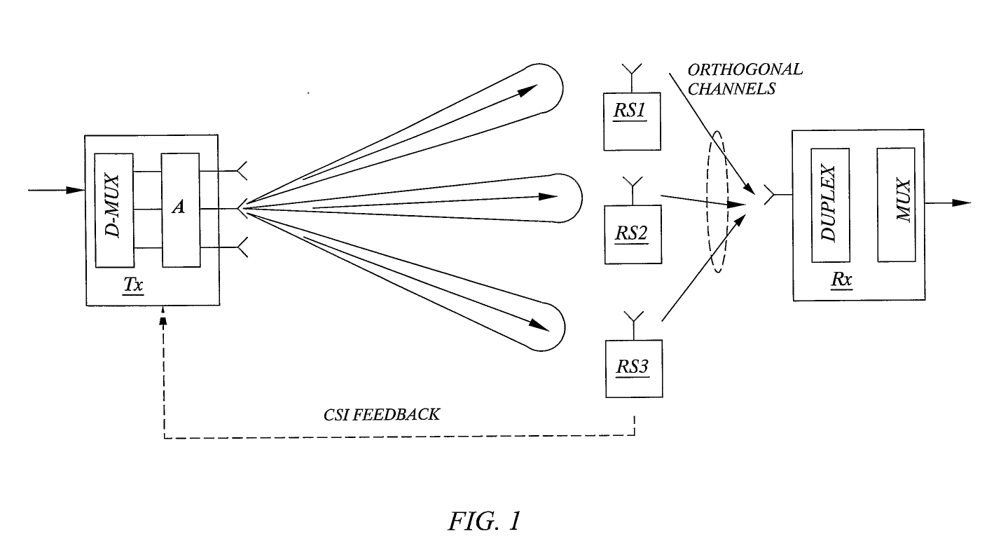

A basic embodiment of a method according to the present invention will be described with reference to the system of FIG. 1. The model system comprises a transmitting node Tx equipped with multiple antennas, three relay nodes RS1, RS2, RS3, and a receiving node Rx. In this general embodiment, the relay nodes and the receiver each have one antenna; however, the invention is not limited to this general embodiment.

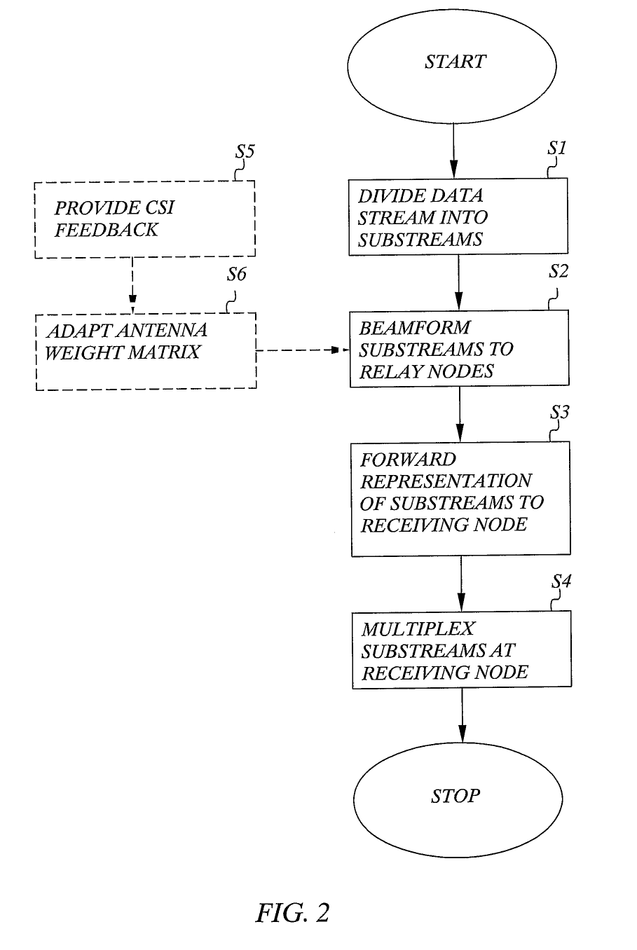

With reference to FIG. 1. and FIG. 2, at some point in time, the transmitter Tx receives a data stream or signal for transmission to the receiver Rx. The data stream is divided or partitioned S1 into a number of data substreams, which are then beamformed and transmitted S2 to at least two relay nodes.

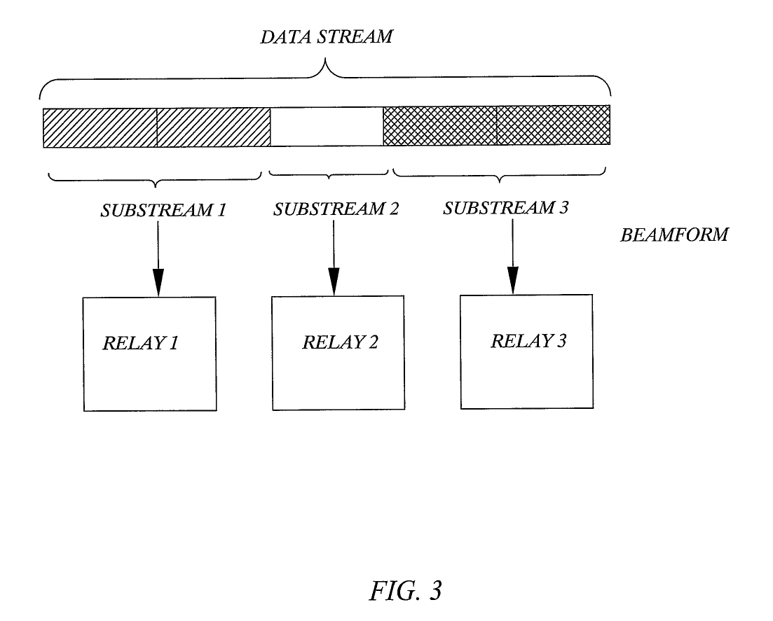

The principle of partitioning the data stream and transmitting each data substream to a respective relay is illustrated in FIG. 3. Accordingly, the data stream is divided (also known as de-multiplexed) into three substreams, each of which is transmitted to a respective relay node. In FIG. 1 there are illustrated three data substreams beamformed one to each respective relay node.

Subsequently, the relay nodes each forwards S3 a restorable or decodable or loss-free representation of the received data substream to the receiving node, which receives and combines or multiplexes S4 the received representations into an output signal corresponding to the data stream originating at the transmitting node.

According to the invention, the data substreams are transmitted to a respective relay (or a respective antenna of a relay, or alternatively to a group of antennas with post-processing that separates the multiple data streams, if the relay has multiple antennas), whereby different parts of the signal travel parallel but different paths in the network. Consequently, what the receiver receives is a plurality of representations of the different substreams of the original signal. Combining the substreams, through individual substream demodulation with subsequent multiplexing of the substreams, is a fairly simple operation, distinctly different from prior art [3]-[6] where the receiver has to jointly decode a plurality of signals, each of which is a superposition of the original signals (corresponding to the substreams).

According to a specific embodiment of the method according to the invention, with reference to FIG. 2, the respective relay nodes provide channel state information S5 to the transmitter node. The channel state information comprises information regarding at least one of the first and the second link. Based on the received channel state information the transmitter adjusts its weighting matrix.

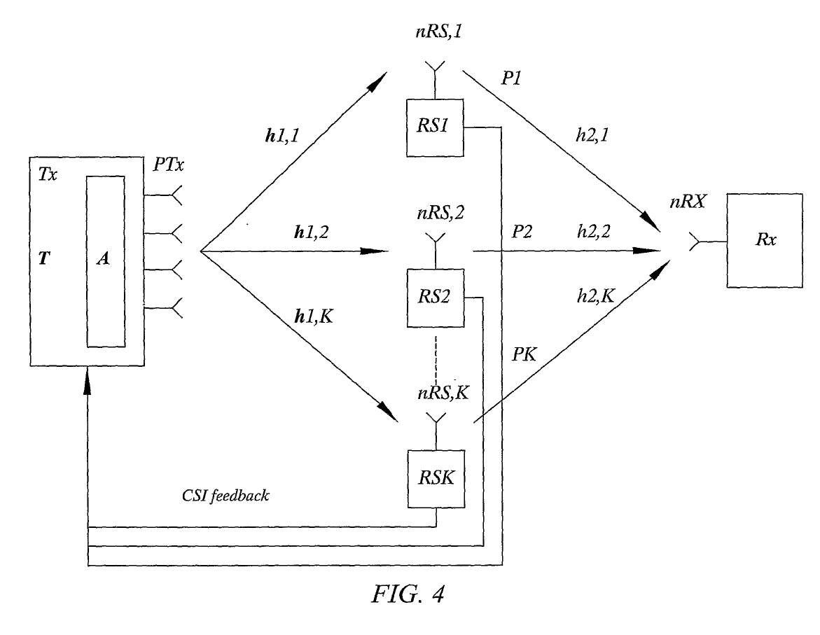

A specific embodiment of the invention will be described with reference to the system illustrated in FIG. 4. The system comprises a transmitting node TX equipped with a plurality of antennas, a plurality of relay nodes RS1, RS2 . . . RSK, and a receiving unit Rx

According to the embodiment, the receiver Rx and each relay RS1, RS2 . . . RSK are each equipped with one single antenna. However, it is equally possible for the receiver and the relays to have multiple antennas as will be described with reference to another specific embodiment.

The transmitter node Tx sends a data stream, converted into parallel modulated and encoded substreams T, through a weighting matrix A. The task of the matrix A is to ensure that data substreams sent to respective relay node over the first link is possible to decode. When the relay node receives the substream, it is decoded, amplified and forwarded to the receiver node, i.e. regenerative relaying. However, the concept in this invention is not limited to the regenerative relaying; it could also be extended to e.g. non-regenerative relaying, wherein each substream is adapted to have a sufficient quality to be decodable or restorable at the receiver. Since different substreams are forwarded, those are sent over orthogonal channels over the second link. The channelization may e.g. be in the frequency, code or time domain. The matrix A is determined through (logical) feedback from the relays as indicated in FIG. 4. Various well-known beamforming weighting schemes can be used to determine A.

In the following, the basic idea of the invention is complemented with a power control scheme. For this purpose, a derivation of performance is performed, and used as guidance when designing the power control scheme. In addition, the invention is also complemented with rules for selecting relay nodes as a secondary outcome of this derivation. The derivation follows below:

The received signal R^{(RS)} at the relay nodes is according to the embodiment.

R^{(RS)}=H·A·T+N^{(RS)}

where T is the signal to be transmitted, A is the transmit weight matrix, H is the channel matrix for the first link, N is the complex Gaussian noise vector at the relay nodes with variance σ₁ₖ². The noise term can also include interference terms that are modeled as complex Gaussian random variables. Note that although this is written in matrix-vector form, it is not possible for each relay node to observe the full receive vector. The total available bandwidth is here divided into (k+1) parts where k is the number of relay nodes.

The channel matrix H may be decomposed in average amplitude path gain matrix, A, and a Rayleigh fading matrix according to

H=A·X

where A=diag{\sqrt{G₁₁}, \sqrt{G₁₂}, . . . , \sqrt{G₁ₖ}} and the elements in X are assumed (i.e. for simplicity here in the derivation) to be complex Gaussian random variables with variance one.

We select the weighting matrix W based on zero-forcing, as

W=X⁻¹

This choice is not necessarily optimum, and not even always possible depending on the invertability of the realization of matrix X, but it is an asymptotically acceptable approximation when the number of transmit antennas at the transmitter is large.

Also note that one may, instead alternatively use a QR-decomposition approach at the transmitter for sending different signals to different relays, e.g. according to [7]. Another version that could potentially be used is w=x*, but it results in interference leakage between the substreams, and hence the each substream rate needs to be adapted to the given signal to interference ratio. Other schemes resulting in acceptable leakage between the MISO transmissions can also be used and the invention is not generally limited to the any specific weight matrix method, such as the w=x⁻¹ scheme, to achieve substantially orthogonal substreams at the relays.

The resulting received signal is then

$$\begin{matrix}{R}^{( RS )} = A \cdot X \cdot {X}^{- 1} \cdot T + {N}^{( RS )} \\ = A \cdot T + {N}^{( RS )}\end{matrix}$$

This means that the SNR at each relay is (well approximated with)

$${Γ}_{1 k} = \frac{{G}_{1 k} {P}_{1 k}}{{σ}_{1 k}^{2}}$$

where P₁ₖ is the average power relates to X and T as

P₁ₖ=E{|X⁻¹·T|^{2}}ₖₖ

(We are going to determine P₁ₖ, which then can be used to determine variance of the element in T. However, if we assume large number of antennas (and relays), then E{|X⁻¹|²}ₖₖ≈Constant, so the radiated power for a substream also relate fairly well to the amount of power before the weighting matrix W. If X happens to be a unitary matrix (which it generally isn't), then the radiated power P₁ₖ is exactly proportional to the power for element k in T)

The SNR at the receiver is

$${Γ}_{2 k} = \frac{{G}_{2 k} {P}_{2 k}}{{σ}_{2 k}^{2}}$$

where G₂ₖ is the path gain from the k:th relay to the receiver, P₂ₖ is the transmit power at the k:th relay, σ₂ₖ² is the noise power at the k:th receive channel at the receiver.

We now want to optimize the aggregate Shannon capacity over the k relays.

First, we argue that the rates must be identical for the first and second link of the k:th relay, i.e.

$${Γ}_{1 k} = {Γ}_{2 k} ⇒ \frac{{G}_{1 k } {P}_{1 k}}{{σ}_{1 k}^{2}} = \frac{{G}_{2 k} {P}_{2 k}}{{σ}_{2 k}^{2}} ⇒ {P}_{2 k} = {P}_{1 k} \frac{{G}_{1 k} {σ}_{2 k}^{2}}{{G}_{2 k} {σ}_{1 k}^{2}}$$

The reason for equal rates is that what is received by a relay must be possible to send. If the rates are unequal, too much information may be received over the first link, or the second link may overprovision capacity and hence waste valuable power resources.

The total capacity (in b/Hz/s) is then

$$\begin{matrix}{C}^{( tot )} = \frac{B}{K + 1} {\sum }_{k = 1}^{K} {lg}_{2} ( 1 + {Γ}_{1 k} ) \\ = \frac{B}{K + 1} {\sum }_{k = 1}^{K} {lg}_{2} ( 1 + \frac{{G}_{1 k} {P}_{1 k}}{{σ}_{1 k}^{2}} )\end{matrix}$$

The capacity shall be maximized under an aggregate power constraint including both transmitter and relays. This is required since there is a rate relation between the first and second link for each relay. The total power is Pₜₒₜ and can be written as:

$$\begin{matrix}{P}_{tot} = {\sum }_{k = 1}^{K} ( {P}_{1 k} + {P}_{2 k} ) \\ = {\sum }_{k = 1}^{K} {P}_{1 k} ( 1 + \frac{{G}_{1 k} {σ}_{2 k}^{2}}{{G}_{2 k} {σ}_{1 k}^{2}} ) \\ = {\sum }_{k = 1}^{K} {P}_{1 k} {c}_{1 k}\end{matrix}$$

Substitute with a (help variable), i.e. the power term ρ₁ₖ=P₁ₖc₁ₖ which gives

$$\begin{matrix}{C}^{( tot )} = \frac{B}{K + 1} {\sum }_{k = 1}^{K} {lg}_{2} ( 1 + \frac{{G}_{1 k} {ρ}_{1 k}}{{σ}_{1 k}^{2} {c}_{1 k}} ) \\ = \frac{B}{K + 1} {\sum }_{k = 1}^{K} {lg}_{2} ( 1 + {ρ}_{1 k} \frac{{G}_{1 k} {G}_{2 k}}{( {G}_{2 k} {σ}_{1 k}^{2} + {G}_{1 k} {σ}_{2 k}^{2} )} ) \\ = \frac{B}{K + 1} {\sum }_{k = 1}^{K} {lg}_{2} ( 1 + \frac{{ρ}_{1 k}}{{\tilde{N}}_{k}} )\end{matrix}$$

With an equivalent noise of

$${\tilde{N}}_{k} = \frac{{G}_{2 k} {σ}_{1 k}^{2} + {G}_{1 k} {σ}_{2 k}^{2}}{{G}_{1 k} {G}_{2 k}}$$

and with the equivalent power constraint

$${P}_{tot} = {\sum }_{k = 1}^{K} {ρ}_{1 k}$$

This problem formulation indicates that the problem falls back to the classical water-filling problem of parallel Gaussian noise channels, i.e. that this tells us to assign most power to the relay paths having the least equivalent noise. As in the classical water-filling problem, it may also occur that the total power is not assigned to all relays, i.e. one or more of the relays having the worst equivalent noise are not used. Since the equivalent noise will differ between the relays, each relay path will support different data rates. If the rates differ, and the transmit durations are fixed, then the amount of information sent over each relay path will differ. Hence, the transmitter may take a higher layer packet and split in smaller packets of different lengths and send those over the different relay paths.

While the power allocation procedure and performance above was derived for a fixed bandwidth, split in K+1 parts, another assumption could be that one from practical viewpoint has near infinite (or at least very large) bandwidth to use for the second link. This assumption could be used for instance if the second link operates on a very high frequency, where bands are often assigned a large fraction of spectrum. By way of example, this is the case of unlicensed spectrum bands at 5.8 GHz, 24 GHz and 60 GHz. The benefit of this is that the K+1 normalization factor in the channel capacity disappears and offers significant increased capacity. This assumption, can be motivated by that the high frequencies band are suitable for short range operation, due to their inherent high path loss, while less suitable for the first link that preferably opts for long range operation.

A coarse relay selection procedure orders all relays in increasing equivalent noise. A subset (out of all relays) containing k relays having the least equivalent noise is then selected. Power and rates are then determined according to equations above. One may stop after this or proceed iteratively until the optimum set of relay nodes is found.

One aspect that needs to be contemplated over is the SNR influence on the number of relays. Assume we start with k relays, and find that a subset of nodes is not allocated any power. If we remove those nodes, then the amount of BW for each relay can be increased, and consequently the SNR will be modified. With this modified SNR, one may anew examine the equivalent noise and allocate power by water filling. This process can be made iteratively to find the optimum number of relays, either by removing the worst station at each step or using a divide and conquer approach.

This procedure could be executed in the sender (e.g. a basestation) with knowledge of the path gains from the BS to the relays and from the relays to the receiver (e.g. a MS)

A particular embodiment according to the invention involves (logical) feedback of channel state information (CSI) from each of the relay nodes back to the transmitter node. The feedback may however take another path, e.g. via the receiver node, or the relay's CSIs may be estimated by the receiver. The feedback provides information regarding the channel state between the relay node and the receiver node. Consequently, the transmitter node can, based on the feedback, adjust the transmit power and/or the bit rate of each substream in order to optimize the transmitted information content. Furthermore, the feedback can be utilized in order to balance the power and/or bit rate between the two links i.e. between the transmitter node and the relay node, and between the relay node and the receiver node.

Channel state information (CSI) is typically assumed to be complex amplitude gain factors, denoted h for scalar values, h for vectors, H for matrixes. For the case of beamforming, phase information is necessary. However, for the second link between a relay node and a receiving node the magnitude of the amplitude gain i.e. |h| is more relevant. For the same link it is also possible to use the channel gain g, i.e. g=|h|². In other words, it is possible to utilize the full CSI at the transmitter, but for this particular case, it is possible to cope on less information for the second link. However, for the case with multiple antennas for at least one of the plurality of relay nodes or the receiver node, the phase is of importance and the full CSI information including the phase information is necessary.

According to another specific embodiment of the invention, the transmitter node and relay nodes allocate power such that the channel capacities, i.e. the SNRs, are similar or identical on the first and second link for each relay node. Possibly, the total power of the transmitter node and the relay nodes can be managed together (e.g. with an aggregate power constraint for both transmitter node antennas and relay nodes) to maximize the joint channel throughput. The control loop primarily includes sending CSI information from the relay nodes to the transmitter node. If the transmitter node is a BS, the links may be fairly stable and allow for fairly slow feedback rate.

Moreover, the quality at the receiver is preferably also involved in a feedback loop. Hence, both the relay and transmitter power, and transmitter transmit weight matrix is adapted when channels change. In addition, the data rates (in conjunction with power allocation) can be assigned for each parallel substream in accordance with the links characteristics, such that overall throughput is maximized. Apart from the shown functions, additional supporting functions exist in the network, e.g. support for mobile receiver, ensuring that “optimal” relays are selected as a receiver is moving. Hence, additional control paths exist to handle additional functions.

According to another specific embodiment of a method of the present invention, the CSI is further utilized in order to select a more or less optimal sub group of the plurality of relay nodes. This can be performed based on maximizing some criteria, e.g. an expected throughput for the system. The substreams can thereafter be beamformed to the selected sub group of relay nodes.

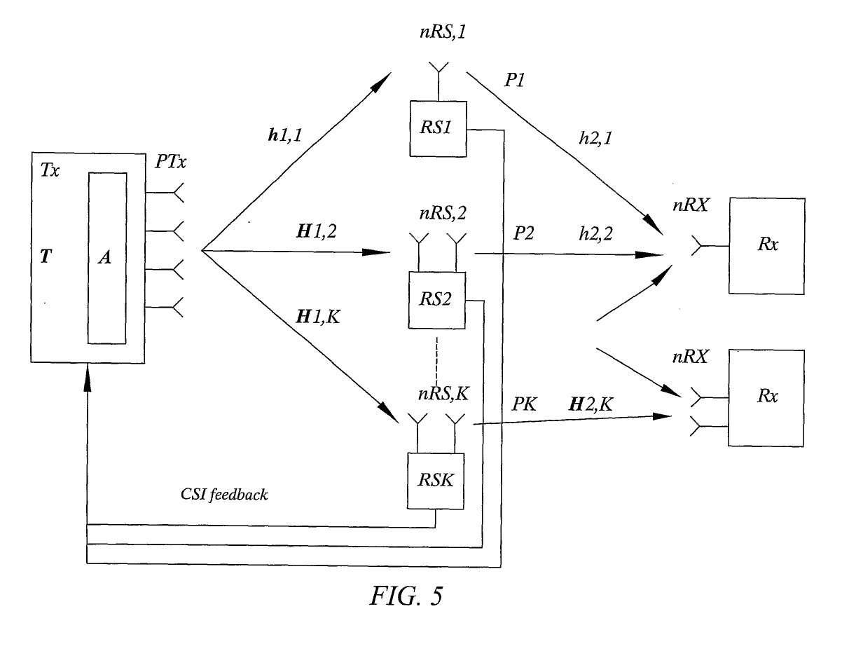

In FIG. 5, the system architecture shown in FIG. 4, has been generalized to comprise relay nodes RS1, RS, . . . , RSK with multiple antennas, multiple receiver nodes Rx, and receiver nodes comprising multiple antennas. The previously described embodiments can be applied to this specific system.

For the situation that a relaying node comprises multiple antennas, the relaying node can be adapted to function according to the following:
Receiving on one antenna and forwarding on multiple antennas.
Receiving on multiple antennas and forwarding on one antenna.
Receiving on multiple antennas and forwarding on multiple antennas.
Receiving on one antenna and forwarding on one antenna.

When receiving with multiple antennas in a relay, the received signals are separated in the relay. This can be achieved by using a weighting matrix Bₖ, wherein the signals from each antenna together with the weighting process, produces as many parallel substantially interference free signal representations of the substreams, as are sent to the relay. If regenerative relaying is utilized, the signal representations of each substreams are decoded and subsequently encoded (e.g. including modulation and forward error correction as is well known in wireless communication) prior transmitting each substream on the orthogonal channels towards the receiver. If non-regenerative relaying is used, the substantially interference free signal representations of the substreams are simply sent on the orthogonal channels towards the receiver.

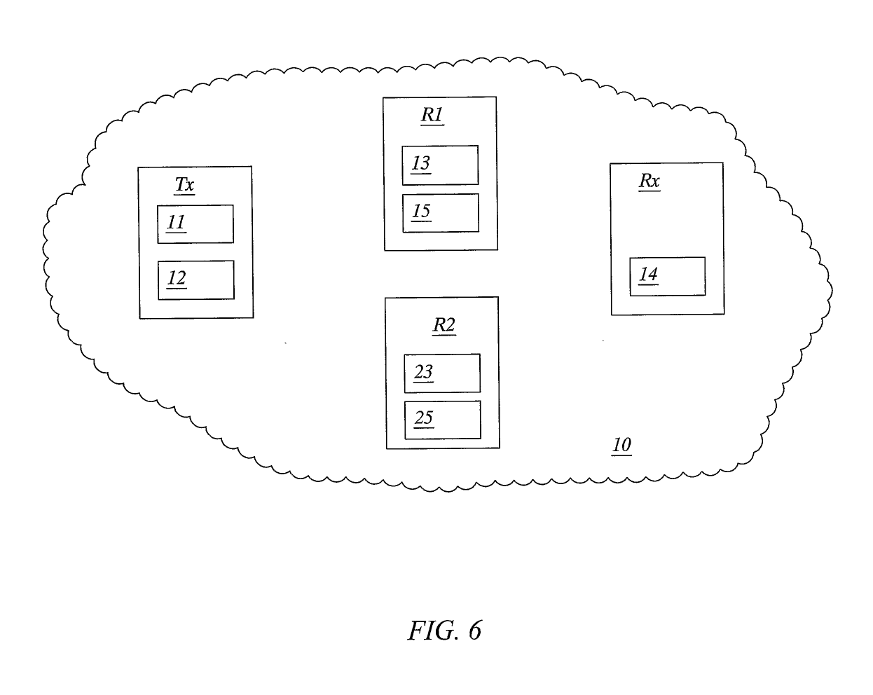

An embodiment of a system 10 enabling improved outer loop power control is illustrated in FIG. 6. The system 10 comprises a transmitting node Tx with multiple antennas, at least two relay nodes R1, R2 and a receiving node Rx.

Further, the system 10 comprises a partitioning unit 11 for partitioning the data stream into multiple data substreams, a beamforming unit 12 for beamforming and transmitting each substream over a first link to a respective of the relay nodes R, receiving units 13; 23 for receiving and forwarding representations of each substream over a second link to the receiving node Rx, a receiving unit 14 for receiving and multiplexing the representations to an output signal, and optional feedback units 15; 25 for providing channel state information (CSI) for the first and second links for each relay node R and the receiving node Rx to the transmitting node Tx.

In the illustrated embodiment the different means 10-15 are organized in a respective of the transmitting node Tx, the two relay nodes R1, R2 and the receiving node Rx. However, it is implied that some of the different means can be located at other nodes or implemented in one and the same node. It is likewise implied that the relay nodes can have multiple antennas, and that there can be provided multiple receiving nodes Rx.

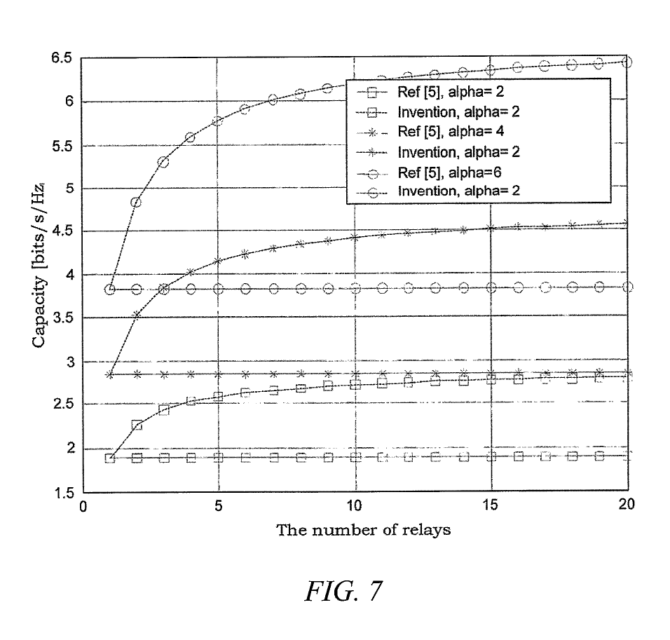

A comparison between prior art according to [6] and the invention is illustrated by the diagram in FIG. 7. The details of the comparison are further described in the Appendix. The diagram illustrates the channel capacity as a function of the number of relays in the system. As is clearly shown, the present invention provides a clear improvement over prior art.

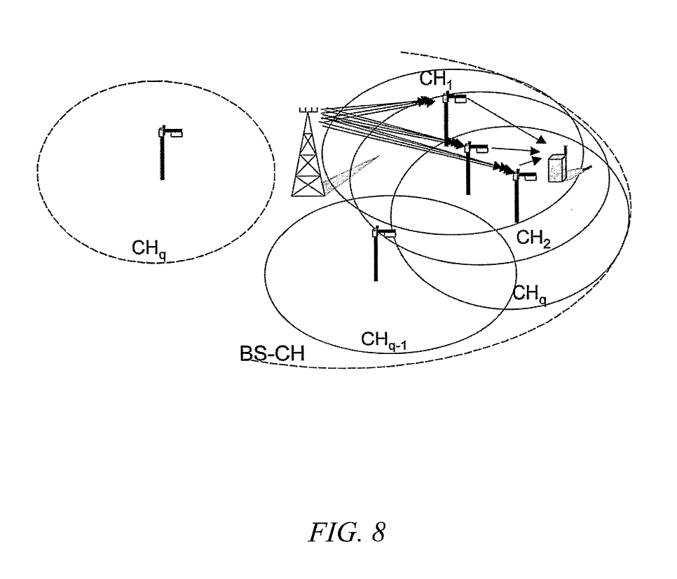

FIG. 8 illustrates how relay nodes can be spatially distributed in the system, here exemplarily attached to lamp poles. It is also shown how channel and transmit ranges are organized for various relay nodes. It is seen that relay coverage for the (substantially) orthogonal channels are overlapping. It is also shown that a channel can be reused multiple times within the same cell such as channel ‘q’ in FIG. 6. Channels may of course also be spatially reused between cells. The relays may be attached not just to lamp poles but also to houses, towers, etc.

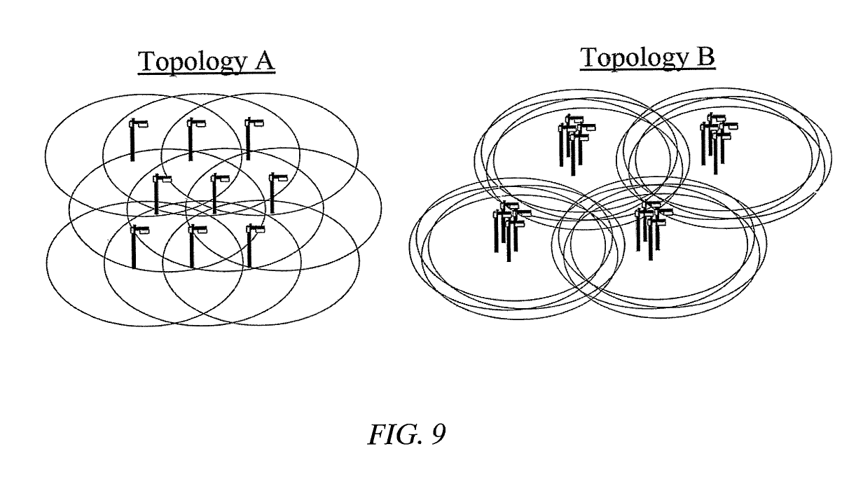

The overlapping coverage regions may also be organized in different ways as shown in FIG. 9. A benefit for Topology A over Topology B is that the quality of a relay link will generally be better, thanks to the proximity of relays. Topology B however has the benefit that clusters of relays can be replaced with a single relay entity having the same number of antennas. Cables, optical fibres or even short-range wireless links, can then connect the antennas.

Although the present invention is described in the context of relaying, the receiver may in addition to one or more relayed substream receive a direct signal, representative of an additional substream, from the transmitter that does not pass via any relay. This direct signal is considered as one of the relayed substreams and hence multiplexed together with the other substreams in the receiver.

Although the present invention is described in the context of a two-hop network, it is also possible to utilize the invention in series. In other words, a data stream can be partitioned into multiple data substreams, beamformed and transmitted to a respective relay node that forwards a decoded, or substantially noise free, version of the substreams it received. Subsequently, at least one of the substreams is further partitioned into at least two sub-substreams and transmitted over a respective path.

To summarize, advantages of the present invention include:
High spectrum efficiency by spatial multiplexing.
Low power consumption by efficiently allocating power between the transmitter and relays.
Low power consumption by efficiently selecting one or more relays offering good communication conditions.
Interference generation reduction by efficiently allocating power between the transmitter and relays. Reduced interference generation has a secondary benefit in that it can increase overall system capacity. (A problem for traditional MIMO is multiple access interference (MAI) from other cells. Thanks to that MAI is reduced, the benefits of MIMO can reveal itself to a greater extent.)
Interference generation reduction by efficiently selecting one or more relays offering good communication conditions.

It will be understood by those skilled in the art that various modifications and changes may be made to the present invention without departure from the scope thereof, which is defined by the appended claims.

### REFERENCES

[1] J. N. Laneman, “Cooperative Diversity in Wireless Networks: Algorithms and Architectures”, Ph.D. Thesis, Massachusetts Institute of Technology, Cambridge, Mass., August 2002.
[2] A. Goldsmith, S. A. Jafar, N. Jindal, S. Vishwanath, “Capacity Limits of MIMO”, Channels”, in IEEE Journal on Selected Areas in Communications, June 2003.
[3] Dohler Mischa (GB); Aghvami Abdol Hamid (GB); Said Fatin (GB); Ghorashi Seyed Ali (GB), patent WO03003672, “Improvements in or Relating to Electronic Data Communication Systems”, Priority date 28 Jun. 2001.
[4] M. Dohler, J. Dominguez, H. Aghvami, “Link Capacity Analysis of Virtual Antenna Arrays” in Proceedings VTC Fall 2002, Vancouver, Canada, September 2002.
[5] M. Dohler, A. Gkelias, H. Aghvami, “2-Hop Distributed MIMO Communication System”, IEEE Electronics Letters, Vol. 39, No. 18, September 2003, pp: 1350-1351.
[6] M. Dohler, A. Gkelias, H. Aghvami, “A Resource Allocation Strategy for Distributed MIMO Multi-Hop Communication Systems”, IEEE Communications Letter, Vol. 8, No. 2, February 2004, pp: 99-101.
[7] G. Ginis and J. M. Cioffi, “A multiuser precoding scheme achieving crosstalk cancellation with application to DSL systems”, in Proc. 34^{th} Asilomar Conf. Signals, Systems and Computers, vol. 2, 2000, pp. 1627-1631.

### APPENDIX

### Performance Comparison Between the Invention and Dohler's Scheme

With all relays placed in the middle between the transmitter and receiver while they are all in a line, the distance from the transmitter to receiver is normalized to 1; the capacity for this invention scheme can be expressed

$${C}_{Invention}^{( tot )} \approx \frac{B \cdot K}{K + 1} \cdot {log}_{2} ( 1 + \frac{{P}_{tot}}{{σ}_{0}^{2}} \cdot \frac{{2}^{α - 1}}{\frac{K}{K + 1}} ) \qquad ( 1 )$$

where B is the total bandwidth, K is the number of relays, Pₜₒₜ is the constraint power, α is the attenuation factor, ρ₀²=k_{V}·T·B is the noise power. The capacity for Dohler's scheme can be expressed

$$\begin{matrix}{C}_{Dohler}^{( tot )} \approx B \cdot {[ \begin{matrix}\frac{1}{{log}_{2} ( 1 + [ 2 - \frac{{β}_{2}}{{α}_{0}} ] \cdot {2}^{α} \cdot \frac{{P}_{tot}}{{σ}_{0}} )} + \\ \frac{1}{{log}_{2} ( 1 + \frac{{β}_{2}}{{α}_{2}} \cdot {2}^{α} \cdot \frac{{P}_{tot}}{{σ}_{0}} )}\end{matrix} ]}^{- 1} \\ \frac{{β}_{2}}{{α}_{2}} \approx 2 \cdot \frac{\sqrt[3]{\frac{{2}^{α}}{{n}_{1}}}}{\sqrt[3]{\frac{{2}^{α}}{{n}_{1}} + \sqrt[3]{\frac{{2}^{α}}{{n}_{2}}}}}\end{matrix} \qquad ( 2 )$$

where n₁ and n₂ are respectively the number of transmitter antenna and relay. For Dohler's scheme, please refer to Equation (4) and (5) in [5].

For fair comparison between two schemes, n₁=n₂=K, thus Equation (2) becomes

$${C}_{Dohler}^{( tot )} \approx \frac{B}{2} \cdot {log}_{2} ( 1 + {2}^{α} \cdot \frac{{P}_{tot}}{{σ}_{0}^{2}} ) \qquad ( 3 )$$

Comparing Equation (3) with Equation (1), it can be seen that C_{Dohler}^{(tot)} is independent on K, while, C_{Invention}^{(tot)} is dependent on K. From FIG. 7, it can be see that there is visible gain for the invention over Dohler's scheme if K>1.

1-30. (canceled)

31. A method for relaying deployment in a wireless communication system comprising a transmitting node with multiple antennas for communicating with at least one receiving node via at least two relay nodes, characterized by:
partitioning a data stream at the transmitting node into at least two data substreams;
beamforming and transmitting each said data substream over a first link to a respective of said at least two relay nodes;
forwarding at least one restorable representation of its received substream over a second link to the at least one receiving node from each of said at least two relay nodes; and
multiplexing the received and decoded restorable/loss-free representations of each substream to form an output signal at said at least one receiving node corresponding to the data stream.

32. The method according to claim 31, characterized by providing channel state information for at least one of said first and second link related to each respective relay node at the transmitting node.

33. The method according to claim 32, characterized in that said channel state information for the second link comprises magnitude of amplitude gain.

34. The method according to claim 32, characterized in that said channel state information for the first link comprises phase information.

35. The method according to claim 32, characterized by providing said channel state information for both of said first and second link.

36. The method according to claim 32, characterized by adapting the weighting matrix for the transmitting node based on at least the received channel information for the first link for each said relay node.

37. The method according to claim 31, characterized in that at least one of said at least two relay nodes comprises multiple antennas.

38. The method according to claim 37, characterized by transmitting separate substreams to at least two of the multiple antennas of said at least one of said at least two relay nodes.

39. The method according to claim 37, characterized by transmitting equal or less number of substreams than the number of multiple antenna elements of said at least one of said at least two relay nodes, and separate substreams through weighting the received signals together.

40. The method according to claim 31, characterized in that said communication system comprises multiple receiving nodes.

41. The method according to claim 40, characterized in that at least one of said multiple receiving nodes comprise multiple antennas.

42. The method according to claim 31, characterized by said at least two relay nodes forwarding their respective at least one representation of their received substreams over orthogonal channels to the receiving node.

43. The method according to claim 35, characterized by allocating available transmit power among the transmitter antennas and the relays, based on the received channel state information for said first and second link.

44. The method according to claim 32, characterized by allocating available transmit power to the substreams and the at least two relay nodes, based on received channel state information for at least one of said first and second link.

45. The method according to claim 32, characterized by allocating data rates to each data substream based on the received channel state information for at least one of said first and second link.

46. The method according to claim 44, characterized by jointly allocating available transmit power to the substreams and said at least two relay node and data rates to each data substream.

47. The method according to claim 32, characterized by selecting at least one relay station that maximize an objective performance measure.

48. The method according to claim 47, characterized by said objective performance measure comprising a link performance measure according to one of throughput or channel capacity.

49. The method according to claim 43, characterized by jointly selecting and allocating any combination of; transmit power, data rates and relay stations based on the received channel state information for at least one of said first and second link.

50. A communication system comprising at least one transmitting node capable of communicating a data stream to at least one receiving node via at least two relay nodes, characterized by:
means for partitioning the data stream at the transmitter node into multiple data substreams;
means for beamforming and transmitting each said data substream over a first link to a respective of said at least two relay nodes; and
means for receiving and forwarding restorable representations of each said data substream over a second link to the receiving node;
means for receiving and multiplexing said restorable representations of each said substream to an output signal corresponding to the transmission data stream.

51. The system according to claim 50, characterized by further means for providing channel state information regarding at least one of said first and second link for each respective relay node and the receiving node to the transmitting node.

52. The system according to claim 51, characterized by further means for adapting the antenna weight matrix based on the provided channel state information for said first link.

53. The system according to claim 51, characterized by means for allocating available transmit power among the substreams and the relays, based on the received channel state information for at least one of said first and second link.

54. The system according to claim 51, characterized by means for allocating available transmit power to the substreams and the at least two relay nodes, based on received channel state information for at least one of said first and second link.

55. The system according to claim 51, characterized by means for allocating data rates to each data substream based on the received channel state information.

56. The system according to claim 54, characterized by means for jointly allocating available transmit power to the multiple transmitter antennas and said at least two relay node and data rates to each data substream.

57. An transmitter node capable of communicating a data stream to at least one receiving node via at least two relay nodes, characterized by:
means for partitioning the data stream into at least two data substreams;
means for beamforming and transmitting each said at least two data substreams over a first link to a respective of said at least two relay nodes.

58. The transmitting node according to claim 57, characterized by:
means for receiving channel state information regarding at least one of the first link to the at least two relay nodes and a second link between the relay nodes and the receiving node;
means for adapting the antenna weight matrix based on the received channel state information for the first link.

59. A relay node enabling relaying deployment in a wireless communication system, said system comprising a transmitting node with multiple antennas communicating with at least one receiving node via at least two relay nodes, characterized by:
means for forwarding a restorable representation of a received substream over a second link to the at least one receiving node; and
means for providing channel state information for at least one of said first and said second link to the transmitting node.

60. A receiver node capable of receiving a partitioned data stream from a transmitting node with multiple antennas over a first link via at least two relay nodes, characterized by:
means for receiving restorable representations of at least one data substream over a second link from each of the at least two relay nodes,
means for multiplexing the received and decoded restorable representations to form an output signal corresponding to the data stream at the transmitting node.
